(19) United States
(12) Patent Application Publication
(10) Pub. No.: US 2008/0162575 A1
(43) Pub. Date: Jul. 3, 2008

(54) REAL ESTATE SIGNBOARD SYSTEM

(75) Inventors: Costa Koulis, Ultimo (AU); Karina Magda Ashboth, Ultimo (AU)

Correspondence Address: BOWDITCH & DEWEY, LLP, 311 MAIN STREET, P.O. BOX 15156, WORCESTER, MA, 01615-0156, US

(73) Assignee: Live Board Holdings Pty Ltd, Ultimo (AU)

(21) Appl. No.: 11/946,472

(22) Filed: Nov. 29, 2007

(30) Foreign Application Priority Data
Nov. 28, 2006 (AU) 2006/246494

(51) Int. Cl. G06F 7/00

(52) U.S. Cl. 707/104.1

(57) ABSTRACT

A system for marketing a real estate property including a real estate user placing an order with a central database over the TCP/IP protocol network for delivery of at least one signboard adapted to display information for marketing a real estate property. The central database preferably has a computer server networked via the TCP/IP protocol with at least one distribution centre. The distribution centre being adapted to prepare, store, repair and deliver the signboards. After receiving the order from the real estate user, the central database transmits a signal over the TCP/IP protocol network to the distribution centre to prepare and deliver a signboard to the real estate property. The real estate property is most often at a location remote to the distribution centre and maintenance centre.

### TECHNICAL FIELD

The present invention relates to a system for marketing a real estate property and in particular to a system for the preparation and delivery of signboards for marketing a real estate property to a remote location.

### BACKGROUND ART

The present invention relates to a system of delivering signboards used for marketing a real estate property that are described in the applicant's own International Patent Publication No. WO 2006/063393.

Traditional real estate signboards do not incorporate a video display unit and are therefore limited to display static information such as photographs, details of the property, contact details of a real estate agent and the like. In the past, a real estate agent would provide a sign printer with details of the real estate property and the sign printer would print the signboard and arrange for delivery of the signboard to the real estate property that is for sale. As traditional signboards do not include dynamic displays, such as can be displayed on a video display screen, conventionally there has been no need to have a system that included the transfer of “live” information between a real estate agent or other real estate user and the signboards that are installed outside a real estate property.

The signboard that is described in WO 2006/063393 includes a lockable, weatherproof housing within which a video display unit, a computer processor, a power supply and a wireless communication module are encased. The video display unit is adapted to display information relating to a real estate property that is for sale and typically is the property that the signboard is placed outside of. The present invention relates to a system for installing the signboard at a predetermined real estate property and installing information relating to that real estate property onto the signboard so that it can be displayed on the video display unit.

The present invention seeks to provide a system for marketing a real estate property that will overcome or ameliorate at least one of the deficiencies of the prior art.

### SUMMARY OF THE INVENTION

In one aspect, the present invention consists in a system for marketing a real estate property comprising at least one distribution centre, at least one real estate user, a central database and a communications network. The distribution centre is adapted to prepare, store, repair, maintain and distribute one or more signboards. The signboards are adapted to market a real estate property. The real estate user requires one or more of the signboards to be installed at real estate property. The communication network operates on a computer system and is adapted to record information that is to be displayed on the signboard, as well to record details of the real estate property. The information and property details are supplied by the real estate user. The communication network connects the distribution centre, real estate user and the central database together. The real estate user can order or update a signboard via the communication network and the distribution centre can obtain orders and maintenance instructions from the central database via the communication network.

Preferably, the communication network is one of the following networks, Code Division Multiple Access (CDMA), Global System for Mobile Communication (GSM), General Packet Radio Service (GPRS), Wireless Internet (Wi-Fi), a Wireless Local Area Network (WLAN) or a landline telephone network.

Preferably, the signboard comprises a substantially weatherproof lockable housing, a video display unit substantially housed within the lockable housing a computer processor housed within said lockable housing for controlling said video display unit and a power supply for providing power to said signboard. The video display unit is adapted to display digital advertisements. The digital advertisements can also include a countdown timer, which is adapted to display time remaining until an event. The computer processor has a communication module allowing for interface between the computer processor and the central database.

Preferably, the communication module includes a wireless communication module allowing for wireless interface between said computer processor and the central database. The wireless interface is via the communication network. The signboard also emits a heartbeat signal at regular intervals to the central database via the communication network, providing an updated status report of the signboard. The signboard needs to be armed to activate the heartbeat signal once the signboard is installed at the real estate property.

According to one embodiment of the present invention, the signboard is armed manually by a person who installs the signboard at the real estate property. According to another embodiment of the present invention, the signboard is armed automatically by the global positioning system (GPS) when the signboard reaches a predetermined location defined by a set coordinates. The predetermined location is the street address of the real estate property.

The signboard is preferably transported from the distribution centre and delivered to the real estate property by a delivery vehicle.

After the signboard is armed and in communication with the central database, the information that is to be displayed on the signboard is automatically downloaded by the signboard from the central database via the communication network.

According to a further embodiment of the present invention, the information that is to be displayed on the signboard is sent to the distribution centre via the communication network and is installed onto the signboard before it is delivered to the real estate property. The information that is to be displayed on the signboard also can be first uploaded by the real estate user to the central database via the communication network.

When the real estate property is sold or under contract, the real estate user updates the central database via the communication network and the information that is displayed on the signboard is automatically updated via the communication network to display a message that the real estate property has been sold or is under contract. An alert is also sent to the distribution centre via the communication network to collect the signboard from the real estate property after a designated period of time and return the signboard to the distribution centre.

Preferably, the computer server of the central database is linked with a plurality of distribution centres via the communication network, each one of the distribution centres servicing a localised area thereto.

Preferably, the information that is displayed on the signboard can be updated to display a Short Message Service (SMS) that is sent via a second mobile communication network to the signboard. The information on the central database can be updated by a person sending a Short Message Service (SMS) via a mobile communication network to the central database, the text of the SMS is then sent to be displayed on the signboard via the communication network.

According to another embodiment of the present invention there is provided, a system for marketing a real estate property whereby a real estate user places an order with a central database. The central database operates on a computer via a first communication network and the real estate user places an order for delivery of at least one signboard, which is adapted to display information for marketing a real estate property. The central database is linked via the first communication network with at least one distribution centre for preparing, storing, repairing, maintaining and distributing one or more of the signboards. After receiving the order from the real estate user, the central database transmits a signal over the first communication network to the distribution centre to prepare and deliver a signboard to the real estate property, at a different location to the distribution centre. The central database is adapted to receive Short Message Service (SMS) information via a second mobile communication network and to then send this SMS information to the signboard via the first communication network. The SMS information can be sent by the real estate user or a third party.

### BRIEF DESCRIPTION OF DRAWINGS

The invention is now discussed with reference to drawings, where:

FIG. 1 is a schematic view of a first embodiment of the system for marketing a real estate property of the present invention;

FIG. 2 is a partial schematic view of the system shown in FIG. 1, where the real estate user sends a message to the installed signboard;

FIG. 3 is a partial schematic view of the system shown in FIG. 1, where a party interested in the real estate property contacts the real estate user via the central database.

### DETAILED DESCRIPTION

Generally, the present invention relates to a system for marketing a real estate property wherein a real estate user can place an online order with a central database for a signboard to be delivered to a real estate property that is to be sold. The signboard is of the kind described in the applicant's own International Patent Publication No. WO 2006/063393 and the signboard includes a video display unit for displaying dynamic information. The system of the present invention also allows a real estate user to quickly and easily update the information that is displayed on the signboard after the signboard has been installed onsite at a real estate property.

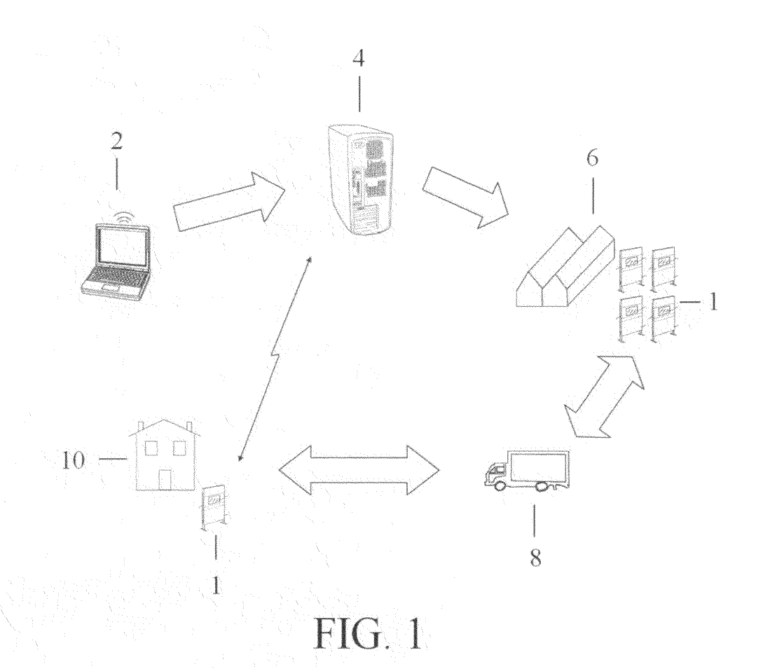

The system of the present invention is best depicted in FIG. 1. The system includes a real estate user 2 who is connected to the system by way of a computer that has a connection to the Internet. This Internet connection can be either through a conventional fixed connection modem, such as broadband DSL, ADSL or dial-up over telephone lines, cable Internet, ISDN, satellite, or the like or alternatively, the connection may be a wireless Internet connection such as a Wireless Internet (Wi-Fi) or a Wireless Local Area Network (WLAN).

The system further includes a central database 4 operating on a computer that is also connected to the Internet. Similarly, this Internet connection can be either through a conventional fixed connection modem, such as broadband DSL, ADSL or dial-up over telephone lines, cable Internet, ISDN, satellite, or the like or alternatively, the connection may be a wireless Internet connection such as a Wireless Internet (Wi-Fi) or a Wireless Local Area Network (WLAN).

The central database 4 further includes a communication module that is adapted to receive information from mobile communication networks including Code Division Multiple Access (CDMA), Global System for Mobile Communication (GSM) and General Packet Radio Service (GPRS). The communication module can also be connected to a landline telephone network.

A real estate user 2 places an order for a signboard 1 for marketing a real estate property 10 with the central database 4 via a communication network that connects the real estate user, central database, distribution centre 6 and signboard together. The communication network is the Internet. Upon receipt of the order for a signboard 1, the central database 4 stores the information relating to the real estate property 10 that is for sale and then transmits an electronic signal to a distribution centre 6 to prepare and deliver a signboard to a real estate property that is being sold. The electronic signal is sent via the Internet.

Each of the distribution centres 6 are adapted to prepare, store, repair, maintain and deliver or distribute the signboards 1. The signboards 1 may be completely manufactured and produced in the distribution centres 6 or the signboards 1 can be only assembled from outsourced parts at the distribution centres. Typically, the signboards 1 will be manufactured elsewhere and supplied to the distribution centre 6 as fully functional units. The distribution centres 6 will be responsible for deployment of signboards 1.

Typically, a distribution centre 6 will service a relatively localised area whilst the central database 4 will service a larger area. For example, using Australia as an example, there may be one national central database 4 and there may be a number of distribution centres 6 throughout the country that service local areas or regions.

The distribution centres 6 are capable of printing text and/or images onto the signboards 1. Each signboard 1 is individually stylised before it is delivered onsite to the real estate property 10. The signboards 1 each has a fixed display mounted on or adjacent the lockable housing that encases the video display unit. The fixed display is adapted to display a fixed advertisement, such as a real estate company's name or logo. However, in other embodiments, it is envisaged that the signboard 1 will include a “full screen” video display unit that is approximately the same size as the front facia of the signboard 1, thus eliminating the need for a fixed display mounted on or adjacent to the lockable housing. It is envisaged that this “full screen” video display unit will be adapted to display both information relating to the real estate property 10 that is for sale, as well as advertisements such as a real estate agent's name or logo.

Upon receipt of the message from the central database 4 that a signboard 1 is needed for a real estate property 10, a person (or persons) at a distribution centre 6 will prepare a signboard for delivery to the real estate property. Once the signboard 1 is ready, it is delivered to the real estate property 10, which is usually at a different location from the distribution centre 6. It is envisaged that delivery of the signboards 1 will be done by using a vehicle 8, such as a delivery van or truck.

Once the signboard 1 has been delivered to and installed at the real estate property 10, the signboard needs to be armed in order to be activated.

In a first embodiment of the system of the present invention, once the signboard 1 is armed, the signboard automatically downloads information that is to be displayed on the video display unit from the central database 4. Preferably, the person from the distribution centre 6 who delivers the signboard 1 to the real estate property 10 will manually arm the signboard. This can be done by inserting a key into an electronic lock, entering in a unique code into a touch pad thereon or other similar means of activation. The information is downloaded via the communication network.

Once the signboard 1 is armed and the information that is to be displayed on the signboard has been downloaded, the signboard emits a “heartbeat” signal at regular intervals to the central database 4 thereafter providing an updated status report of the signboard. A “heartbeat” according to this specification means a signal emitted at regular intervals by software or hardware to demonstrate that it is active. Hardware can be designed to reboot a machine if it stops receiving a heartbeat signal. If the heartbeat signal stops, the central database 4 will automatically send an electronic message to the distribution centre 6 via a communication network for a person from the distribution centre to go and collect the signboard 1. It may be more cost effective for a person from the distribution centre 6 to simply go and replace the potentially faulty signboard 1 that is installed at the real estate property 10 with a new signboard and return the potentially faulty signboard to the distribution centre for repairs. Alternatively, onsite repairs may also be carried out on the potentially faulty signboard 1.

The heartbeat signal is sent from a communication module located within the signboard 1 by one or more of the following networks, Code Division Multiple Access (CDMA), Global System for Mobile Communication (GSM), General Packet Radio Service (GPRS), Wireless TCP/IP protocol (Wi-Fi), a Wireless Local Area Network (WLAN) or a landline telephone network. The communication module that sends the heartbeat signal is located within the secure enclosure of the signboard 1 and is not easily removed.

The signboard 1 includes a computer processor that is adapted to monitor the status of the signboard. Information that can be monitored by the computer processor includes the status of the battery, whether the signboard 1 is powered on and operational, if the video display unit is functioning correctly, whether data and other information is being transferred properly between the computer processor and the video display unit and whether the signboard has been pushed over or removed from its original installation site. This information can be regularly transmitted to the central database 4 via the communication network.

The communication network that the heartbeat is sent over further allows for the information displayed on the signboard 1 to be updated by a real estate user 2 after the signboard has been installed at the real estate property 10. A real estate user 2 can update the information that is stored on the central database 4 via the Internet. After the information has been updated on the central database 4, the information that is displayed on the signboard 1 is automatically updated via the communication network.

For example, when a real estate user 2 negotiates the sale of the real estate property 10, the real estate user can update the information that is displayed on the signboard 1 to display a message that the real estate property has been sold or is under contract or negotiation. A real estate user 2 may also update the information that is displayed on the signboard 1 to display advertisements for services in the local area or of paying sponsors, other similar real estate properties that may be in the area or other similar information.

The central database 4 may also have a database of advertisements that can be displayed on the signboard 1 at regular intervals during the time that the signboard is installed onsite at a real estate property 10. Preferably, these advertisements would be tailored for each specific signboard 1, in so far as the advertisements would relate to services in the local area that the signboard has been installed at. The central database 4 may contain an extensive list of advertisements ranging from a number of different local areas. When a signboard 1 is installed at a real estate property 10, the central database will identify which of the advertisements in the extensive database correspond with the local area that a particular signboard is installed at, and will automatically upload the corresponding advertisements via the communication network for display on the signboard.

Additionally, once the real estate property 10 has been sold, the signboard 1 can be updated to display other similar properties in a similar location so that potential sales may be obtained. The real estate user 2 is preferably a real estate agent or real estate agent company and as such, will usually have multiple properties on their books that are for sale within a location. Thus, once the real estate property 10 that has been sold using the signboard 1 of the present invention, the real estate user 2 may update the information on the central database 4 by the communication network. This updated information can include details of other similar properties within the same or nearby locations. The central database will then automatically update the information that is to be displayed on the signboard 1 to show these other properties or the like.

When the real estate property 10 has been successfully sold and the real estate user 2 updates the information on the central database 4 to display a message on the signboard 1 stating that the property has been sold, an alert is also automatically sent from the central database 4 to a distribution centre 6 for a person or persons to go and collect the signboard from the real estate property on a specified date. Preferably, the signboard 1 will remain installed at the real estate property 10 for a predetermined period of time after the sale of the real estate property has been finalised, to advertise to observers that the real estate user 2 has successfully sold the real estate property. This is a similar process as conventional real estate signboards. The length of time that the signboard 1 remains installed at the real estate property 10 after the sale has been finalised is typically between two to six weeks.

A person or persons from the distribution centre 6 will come out and collect the signboard 1 shortly before, on or shortly after the predetermined date for collection established by the real estate user 2. After collecting the signboard 1, the person or persons will return the signboard to a distribution centre 6 by a vehicle 8 and a person or persons at the distribution centre will assess whether any repairs need to be made to the signboard. The person or persons who collects the signboard 1 from the real estate property 10 by means of a delivery vehicle 8 is not necessarily the same person or persons who assesses the signboard for what repairs or other maintenance may be required. If repairs or maintenance are deemed to be necessary, a person or persons from the distribution centre 6 will repair the signboard 1. The signboard 1 is then either stored until it is needed to be delivered to a new real estate property 10 or it is immediately prepared for delivery to a new real estate property as hereinbefore described.

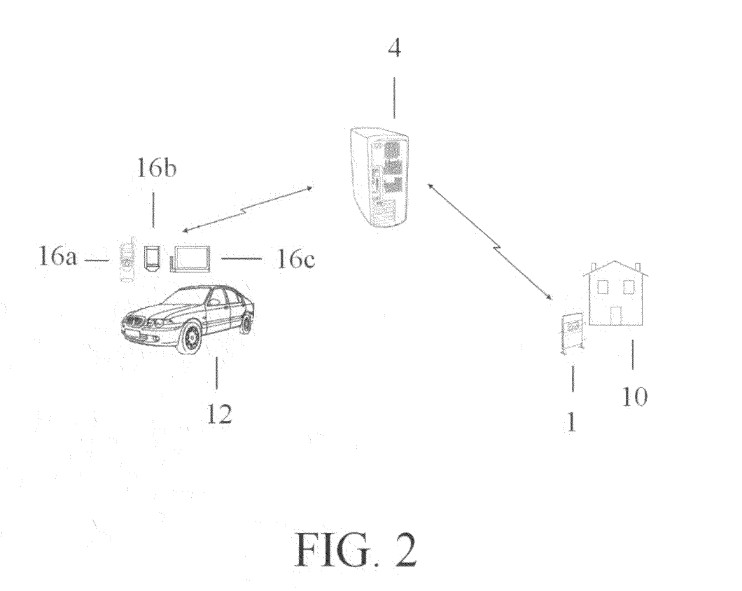

As best shown in FIG. 2, a real estate agent 12 may update the information that is displayed on the signboard 1 instantaneously and from remote locations by a mobile telephone 16a, personal data assistant (PDA) 16b or wireless equipped noteBook computer 16c via a mobile or wireless communication network. A real estate agent 12 can send a message to be displayed on the signboard 1 to the central database 4. This message is sent from the central database 4 to the signboard 1 via the communication network.

For example, if a real estate agent 12 is running late for an inspection of a real estate property 10, the real estate agent can send a message either as a Short Message Service (SMS) or as an email to the central database 4 via a mobile or wireless communication network. This message is then sent to the signboard 1 via the communication network to be displayed on the signboard. The message from the real estate agent 12 can inform those who may wish to inspect the property 10 that the real estate agent is running late. A real estate agent 12 can also instantly update information that is displayed on a signboard 1 when they are onsite by sending a message to the central database 4 via a mobile or wireless communication network. The message is then sent from the central database 4 to the signboard 1 via the communication network to be displayed on the signboard. For example, a person who has inspected the house may make an offer to the real estate agent 12 to buy the real estate property 10 whilst they are still onsite. The real estate agent 12 may then instantaneously display a message on the signboard 1 that an offer has been made on the real estate property.

The central database 4 may be configured to include a set of standard messages that can be displayed on the signboard 1. Preferably, each of the standard messages has a corresponding unique code. In this embodiment, a real estate agent 12 may simply message one of a plurality of unique codes in order for the corresponding standard messages to be displayed on the signboard. This eliminates or at least reduces the potential for errors, and particularly spelling and grammatical errors, to be made in the messages that are displayed on the signboards 1, which may present an unfavourable and unprofessional image of a real estate company that is using the signboard to sell a real estate property 10.

If a real estate agent 12 should visually identify that a signboard 1 has been damaged or vandalised in some way, the real estate agent can send a message that the signboard needs repair or replacement to the central database 4 by a mobile telephone 16a, PDA 16b or wireless equipped noteBook computer 16c via a mobile or wireless communication network. The real estate agent 12 will either have to manually identify which signboard 1 needs to be repaired or replaced by including the address of the real estate property 10 that the signboard is installed outside of or including a unique identifying code that each of the signboards comprises. Alternatively, the location of the signboard 1 that needs to be repaired or replaced can be determined automatically by the GPS recording the coordinates of the location of the real estate agent 12 when they send the message to the central database 4.

The central database 4 will then automatically send a message to the nearest distribution centre 6 to the signboard 1 that needs attention, to arrange for a person to go out to the signboard that is in need of repair or replacement. The message from the central database 4 to the distribution centre 6 is sent via the communication network.

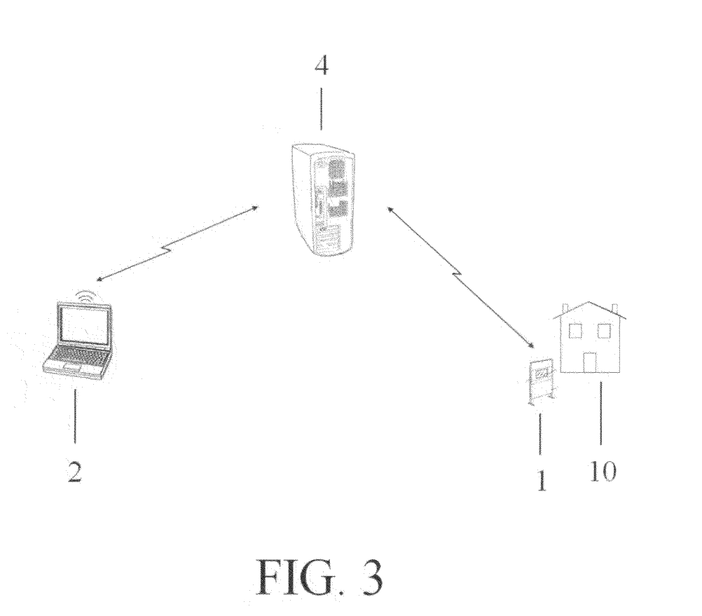

As shown in FIG. 3, a third party that is interested in buying a real estate property 10 can send an offer to purchase the property 10 to the real estate user 2 that is offering the real estate property for sale. This offer can be sent via the communication network. After an interested party sends a message via a mobile or wireless communication network to the central database 4, the message is forwarded onto the real estate user 2. An interested party can also upload their details to the central database 4 and optionally have their details sent onto the real estate user, so that the real estate user who is selling the real estate property 10 can get in contact with the interested party in the future.

For example, the signboard 1 may display a phone number that an interested party can send an SMS to with an offer to buy the real estate property 10. This phone number would allow the messages that are sent by any interested parties to be stored on the central database 4 and optionally be sent onto the real estate user 2. Alternatively, the signboard 1 may display a website that an interested party can access and submit an offer to buy the real estate property 10 thereon, which will also upload the message to the central database 4 and optionally to the real estate user 2.

It is envisaged that if an interested party uploads their details to the central database 4 via the communication network, their details will be stored. The details may include a contact name and number, address and the like. Should the offer to buy the real estate property 10 that the interested party makes be satisfactory to the real estate user 2, a message to this effect can be transmitted from the real estate user to the central database 4 via the communication network. This message will then be sent to the interested party via a mobile or wireless communication network.

In a second embodiment of the system of the present invention, the information that is to be displayed on the signboard 1 is sent from the central database 4 to the distribution centre 6 via the Internet. When a person is preparing the signboard 1 at the distribution centre 6, they upload this information onto the signboard by connecting the signboard to a computer before the signboard is delivered to a real estate property 10.

In another embodiment of the present invention, the signboard 1 can be armed automatically. In this embodiment, the signboard 1 comprises a GPS unit that will trigger the signboard to be armed once the signboard reaches a predetermined location. The GPS unit determines when the signboard 1 reaches this predetermined location by reading the coordinates and matching them to a set of coordinates that are initially provided by the real estate user 2. The set of coordinates preferably correspond to a real estate property 10 that is for sale. Preferably, once the signboard 1 reaches the desired location, the GPS unit will trigger the signboard to go into a “standby mode” for a set period of time before the signboard arms itself. This allows time for a person from the distribution centre 6 to unload the signboard 1 from the delivery vehicle 8 and install the signboard outside a real estate property 10 before the signboard is armed.

In another embodiment of the present invention, the signboards 1 can be partially assembled at a different location to the distribution centres 6 and shipped to the distribution centres in a partially assembled state for final assembly at the distribution centres. In yet another embodiment of the present invention, the signboards 1 may be produced or manufactured entirely at the distribution centres 6.

The term “comprising” (and its grammatical variations) as used herein is used in the inclusive sense of “having” or “including” and not in the exclusive sense of “consisting only of”.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A system for marketing a real estate property comprising:
at least one distribution centre for preparing, storing, repairing, maintaining and distributing one or more signboards adapted to market a real estate property;
at least one real estate user requiring one or more of said signboards to be installed at real estate property;
a central database operating on a computer system for recording information that is to be displayed on the signboard and details of the real estate property, said information and property details are supplied by the real estate user;
a communications network connecting the distribution centre, real estate user and the central database together;
whereby, the real estate user can order or update a signboard via said communication network; and
the distribution centre can obtain orders and maintenance instructions from the central database via the communication network.

2. The system of claim 1 wherein the communication network is one of the following networks, Code Division Multiple Access (CDMA), Global System for Mobile Communication (GSM), General Packet Radio Service (GPRS), Wireless Internet (Wi-Fi), a Wireless Local Area Network (WLAN) or a landline telephone network.

3. The system of claim 1 wherein the signboard comprises:
a substantially weatherproof lockable housing,
a video display unit substantially housed within said lockable housing and adapted to display digital advertisements, said digital advertisements including a countdown timer adapted to display time remaining until an event;
a computer processor housed within said lockable housing for controlling said video display unit, and
a power supply for providing power to said signboard
wherein said computer processor has a communication module allowing for interface between said computer processor and the central database.

4. The system of claim 3 wherein said communication module includes a wireless communication module allowing for wireless interface between said computer processor and the central database.

5. The system of claim 4 wherein said wireless interface is via the communication network.

6. The system of claim 1 wherein the signboard emits a heartbeat signal at regular intervals to the central database via the communication network providing an updated status report of the signboard.

7. The system of claim 6 wherein the signboard needs to be armed to activate the heartbeat signal once the signboard is installed at the real estate property.

8. The system of claim 7 wherein the signboard is armed manually by a person who installs the signboard at the real estate property.

9. The system of claim 6 wherein the signboard is armed automatically by the global positioning system (GPS) when the signboard reaches a predetermined location defined by a set coordinates.

10. The system of claim 9 wherein the predetermined location is the street address of the real estate property.

11. The system of claim 1 wherein the signboard is transported from the distribution centre and delivered to the real estate property by a delivery vehicle.

12. The system of claim 7 wherein after the signboard is armed and in communication with the central database, the information that is to be displayed on the signboard is automatically downloaded by the signboard from the central database via the communication network.

13. The system of claim 7 wherein the information that is to be displayed on the signboard is sent to the distribution centre via the communication network and is installed onto the signboard before it is delivered to the real estate property.

14. The system of claim 11 wherein the information that is to be displayed on the signboard is first uploaded by the real estate user to the central database via the communication network.

15. The system of claim 13 wherein the information that is to be displayed on the signboard is first uploaded by the real estate user to the central database via the communication network.

16. The system of claim 1 wherein when the real estate property is sold or under contract,
the real estate user updates the central database via the communication network and the information that is displayed on the signboard is automatically updated via the communication network to display a message that the real estate property has been sold or is under contract; and
an alert is sent to the distribution centre via the communication network to collect the signboard from the real estate property after a designated period of time and return the signboard to the distribution centre.

17. The system of claim 1 wherein the computer server of the central database is linked with a plurality of distribution centres via the communication network, each one of said distribution centres servicing a localised area thereto.

18. The system of claim 1 wherein the information that is displayed on the signboard can be updated to display a Short Message Service (SMS) that is sent via a second mobile communication network to the signboard.

19. The system of claim 1 wherein the information on the central database can be updated by a person sending a Short Message Service (SMS) via a mobile communication network to the central database, the text of the SMS is then sent to be displayed on the signboard via the communication network.

20. A system for marketing a real estate property including:
a real estate user placing an order with a central database operating on a computer via a first communication network for delivery of at least one signboard adapted to display information for marketing a real estate property;
the central database is linked via the first communication network with at least one distribution centre for preparing, storing, repairing, maintaining and distributing one or more signboards;
after receiving the order from the real estate user, the central database transmits a signal over the first communication network to the distribution centre to prepare and deliver a signboard to the real estate property;
the real estate property is at a different location to the distribution centre; and
wherein the central database is adapted to receive Short Message Service (SMS) information via a second mobile communication network and to then send this SMS information to the signboard via the first communication network.

21. The system of claim 18, wherein the SMS information is sent by the real estate user.

22. The system of claim 18, wherein the SMS information is sent by a third party.
